(19) United States
(12) Patent Application Publication
(10) Pub. No.: US 2025/0191839 A1
(43) Pub. Date: Jun. 12, 2025

(54) MANUFACTURING METHOD OF SMD NETWORK TRANSFORMER

(71) Applicant: CHONGQING HENGNUO ELECTRONICS CO., LTD, Chongqing (CN)

(72) Inventor: Muhua JIANG, Chongqing (CN)

(21) Appl. No.: 18/961,881

(22) Filed: Nov. 27, 2024

(30) Foreign Application Priority Data
Dec. 12, 2023 (CN) 2023117055119

(51) Int. Cl. H01F 41/10; H01F 19/00; H01F 27/29; H01F 27/32; H01F 41/12

(52) U.S. Cl. CPC H01F 41/10; H01F 19/00; H01F 27/292; H01F 27/327; H01F 41/127; H01F 2027/295

(57) ABSTRACT

A manufacturing method of an SMD network transformer is provided. The method includes providing a metal material sheet and a plurality of coils. The metal material sheet can include a substrate, metal PINs, and an auxiliary sheet. A left and/or right side end of the metal PINs can be connected with the auxiliary sheet. A cross-section of the metal PINs can be exposed. The coil can include a magnetic ring and a copper wire. The method can include tapping the copper wires on the coils, welding wire ends of the copper wires on the metal PINs to form welding positions, and packaging the welding positions through a glue material. The glue material can form a glue frame. The glue frame can wrap the welding positions. The method can include packaging the coils in the glue frame, cutting the auxiliary sheet, taking down the substrate and the auxiliary sheet, and bending and shaping the metal PINs to form a product.

### CROSS-REFERENCE TO RELATED APPLICATION

This application is based on and claims the benefit of priority from Chinese Patent Application No. 2023117055119, filed on Dec. 12, 2023, the entirety of which is incorporated by reference herein.

### TECHNICAL FIELD

The present disclosure relates to the technical field of network transformers, and in particular, to a manufacturing method of an SMD network transformer.

### BACKGROUND

A network transformer mainly includes a coil, a metal PIN and a packaging block, where a copper wire of an internal coil of the network transformer is connected to the metal PIN, and then subjected to injection molding.

However, in actual production, sometimes it is necessary to package the coil to prevent the coil from loosening, and sometimes it is not necessary to package the coil to avoid the coil inside the glue material being wrapped by the glue material, which will cause a magnetic ring of the coil to be stressed by the glue material, and an inductance value of the coil will be seriously attenuated, thus affecting a performance of a product. These two methods conflict with each other. If the network transformers are manufactured separately, device cost will be high.

### SUMMARY

The present disclosure aims at solving at least one of the technical problems in the existing technology. To this end, the present disclosure provides a manufacturing method of a Surface Mounted Device, SMD, network transformer. By manufacturing a glue frame as an intermediate piece, a welding position is packaged, which is convenient for subsequent bonding and complete packaging of coils in the glue frame.

A manufacturing method of an SMD network transformer according to an embodiment of a first aspect of the present disclosure includes the following steps of: welding coils: taking a metal material sheet and a plurality of coils, the metal material sheet including a substrate, a plurality of metal PINs and an auxiliary sheet, at least one of a left side end and a right side end of each of the plurality of metal PINs being connected with the auxiliary sheet, a cross section of each of the plurality of metal PINs being exposed, the plurality of coils each including a magnetic ring and a copper wire, tapping the respective copper wire on the plurality of coils, and welding a wire end of the respective copper wire on a respective one of the plurality of metal PINs at a corresponding position to form a respective one of a plurality of welding positions; performing frame injection molding: packaging the welding positions through a glue material in an injection molding mode, the glue material forming a glue frame after the injection molding, and the glue frame wrapping the welding positions; packaging: packaging the coils in the glue frame by using the glue material again; and finishing: cutting the auxiliary sheet, taking down the substrate and the auxiliary sheet together, and bending and shaping the plurality of metal PINs to form a product.

The manufacturing method of the SMD network transformer according to the embodiment of the present disclosure at least has the following beneficial effects. The metal sheet is arranged so that all surfaces of the metal PIN can be electroplated during electroplating, and the metal sheet and the metal PIN are in an integral structure, which is more convenient for welding operation and injection molding and packaging the welding positions. In addition, performing injection molding on the glue frame as an intermediate piece can provide a product base for subsequent production of network transformers in different forms, save a cost of adopting two production lines, achieve overall planning of production processes, save costs, and improve production efficiency. The coil can be fixed and packaged by dispensing on a glue injection whole of the glue frame and the metal sheet, or the coil can be completely packaged by pouring glue.

According to some embodiments of the present disclosure, in the packaging step, a cover is further introduced, the cover is mounted on a side of the glue frame, and the coils are stuck to the glue frame by dispensing at an open side of the glue frame. After injection molding, the glue frame is fitted with the cover, and after the cover is fitted, one side of the glue frame is open, and then the coil is fixed by dispensing, so that a problem that the coil is wrapped by the glue does not exist, and the magnetic ring in the coil is not stressed by the encapsulated glue, thus solving a problem of inductance value attenuation of the coil.

According to some embodiments of the present disclosure, in the packaging step, the coils are stuck in the glue frame with the glue material first, and then an interior of the glue frame is filled by a secondary injection molding mode, so that the coils are packaged. In the manufacturing process, the flowing glue is completely blocked and controlled in a designated area, which makes the production convenient and easy to operate. Meanwhile, the coils and the welding positions in the glue frame are packaged in the glue frame, so that the coils are not loosened, the copper wires are not scratched and the welding positions of the copper wires are not oxidized, so that a product quality is improved.

According to some embodiments of the present disclosure, the glue frame is provided with an external concave part.

According to some embodiments of the present disclosure, the plurality of metal PINs each is provided with a respective one of a plurality of welding auxiliary grooves, and in the step of welding the coils, the wire end for each of the plurality of coils is bent and accommodated in a respective one of the plurality of auxiliary welding grooves after being drawn out and then is welded. The welding auxiliary groove provided is convenient for limiting the wire end at an initial stage of welding, and is convenient for subsequent welding.

According to some embodiments of the present disclosure, the plurality of metal PINs include a first group of metal PINs and a second group of metal PINs oppositely arranged in a front-back direction, an installation space is reserved between the first group of metal PINs and the second group of metal PINs, and both the first group of metal PINs and the second group of metal PINs include a plurality of metal PINs arranged in a left-right direction.

According to some embodiments of the present disclosure, each of the plurality of metal PINs includes a respective one of a plurality of packaging parts and a respective one of a plurality of contacting parts, each of the welding auxiliary grooves is defined on respective one of the plurality of packaging parts, and the wire end for each of the plurality of coils is connected to the welding auxiliary groove on the respective one of the plurality of packaging parts.

According to some embodiments of the present disclosure, the packaging part and the contacting part are integrally formed for each of the plurality of metal PINs, and a width of the packaging part is greater than a width of the contacting part, so that the packaging parts can be better packaged, and a strength of the packaged metal PINs is improved; in addition, a stress at a joint of the packaging parts and the contacting parts can be improved, and the contacting parts can be bent conveniently in a later stage.

According to some embodiments of the present disclosure, a fillet structure is arranged at a joint of the packaging part and the contacting part for each of the plurality of metal PINs.

According to some embodiments of the present disclosure, each of the plurality of contacting parts is provided with a respective one of a plurality of bending steps each configured to bend a respective one of the plurality of contacting parts.

Additional aspects and advantages of the present disclosure will be given in part in the following description, and will become apparent in part from the following description, or will be learned through the practice of the present disclosure.

### BRIEF DESCRIPTION OF THE DRAWINGS

The above and/or additional aspects and advantages of the present disclosure will be more apparent from the following description of the embodiments in conjunction with the accompanying drawings, where:

FIG. 1 is a schematic diagram of a metal material sheet injection molded with a glue frame according to an embodiment of the present disclosure;

FIG. 2 is an exploded view of FIG. 1;

FIG. 3 is a schematic diagram of the glue frame with a coil completely packaged by injecting glue;

FIG. 4 is an exploded view of FIG. 3;

FIG. 5 is a schematic diagram of the glue frame with a cover thereon;

FIG. 6 is an exploded view of FIG. 5; and

FIG. 7 is a flowchart showing a manufacturing method of an SMD network transformer.

### DETAILED DESCRIPTION

The embodiments of the present disclosure will be described in detail hereinafter. Examples of the embodiments are shown in the drawings. The same or similar reference numerals throughout the drawings denote the same or similar elements or elements having the same or similar functions. The embodiments described below by reference to the accompanying drawings are exemplary and are intended only to illustrate the present disclosure and are not to be construed as limiting the present disclosure.

In the description of the present disclosure, it shall be understood that the orientation or position relation related to the orientation description, such as the orientation or position relation indicated by the up, down, front, rear, left, right, etc., is based on the orientation or position relation shown in the drawings, which is only used for convenience of description of the present disclosure and simplification of description instead of indicating or implying that the indicated device or element must have a specific orientation, and be constructed and operated in a specific orientation, and thus shall not be understood as a limitation to the present disclosure.

In the description of the present disclosure, the meaning of several refers to be one or more, and the meaning of multiple refers to be more than two. The meanings of greater than, less than, more than, etc., are understood as not including this number, while the meanings of above, below, within, etc., are understood as including this number. If there is a description to the first and second, it is only for the purpose of distinguishing technical features, and shall not be understood as indicating or implying relative importance, implicitly indicating the number of the indicated technical features or implicitly indicating the order of the indicated technical features.

In the description of the present disclosure, unless otherwise explicitly defined, words such as setting, mounting and connecting should be understood a broad sense, and those skilled in the art can reasonably determine the specific meanings of the above words in the present disclosure in combination with the specific contents of the technical solutions.

As is referenced below, reference numeral 100 is a metal material sheet, reference numeral 110 is a substrate, reference numeral 120 is a metal PIN, reference numeral 121 is a packaging part, reference numeral 122 is a contacting part, reference numeral 122a is a bending step, reference numeral 123 is a welding auxiliary groove, reference numeral 130 is an auxiliary sheet, and reference numeral 140 is a welding position.

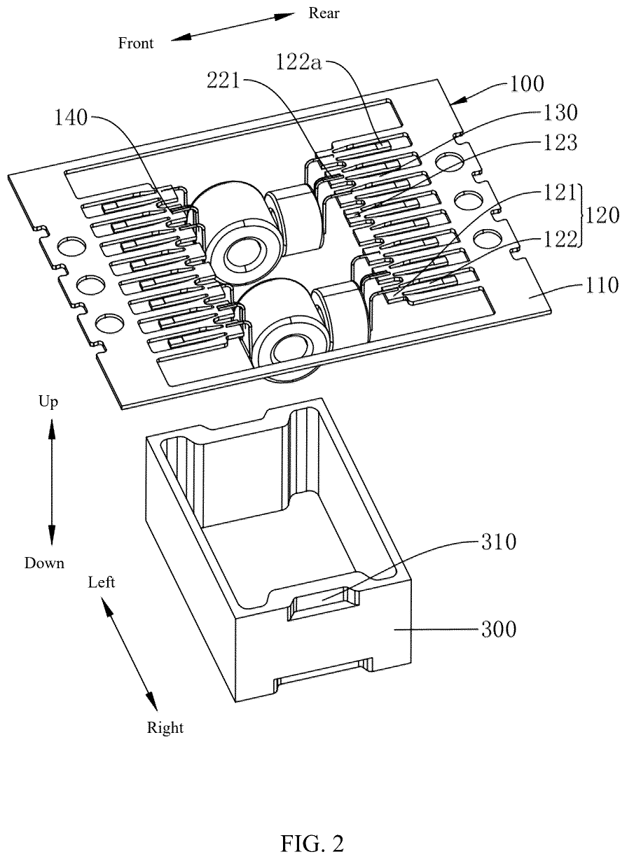

As shown in FIG. 2, reference numeral 200 is a coil, reference numeral 210 is a magnetic ring, reference numeral 220 is a copper wire, and reference numeral 221 is a wire end.

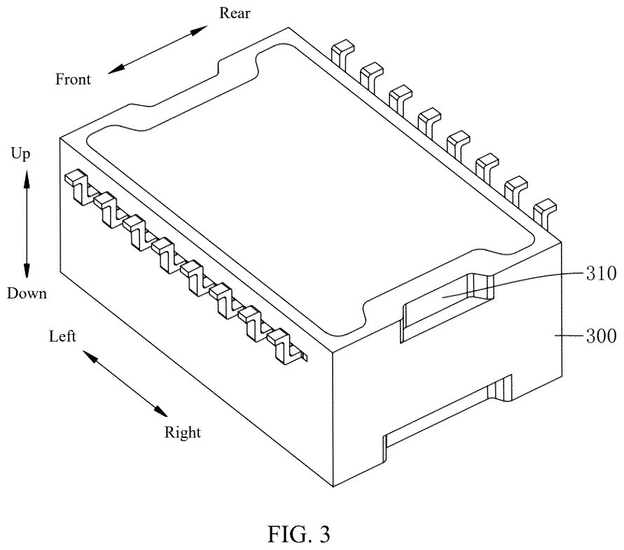

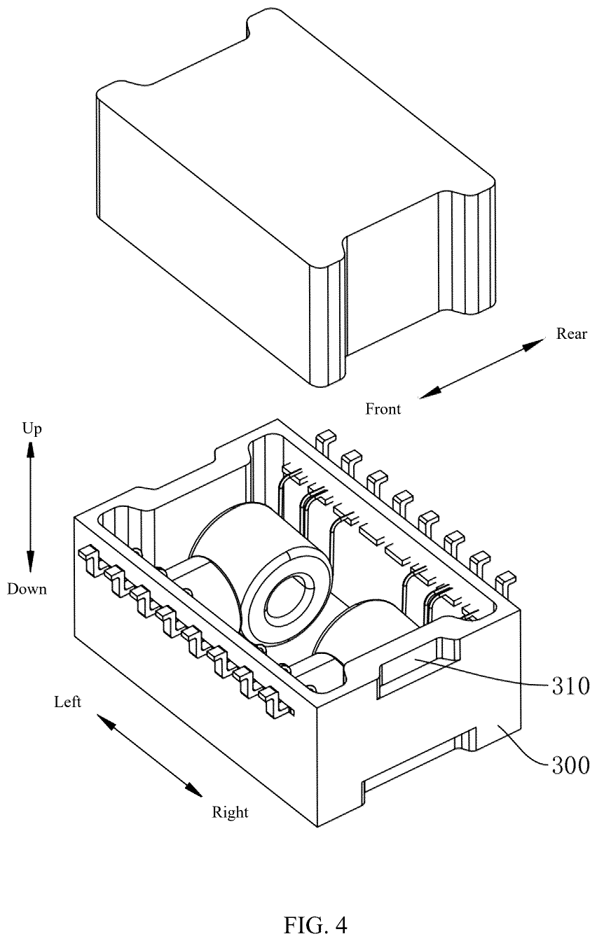

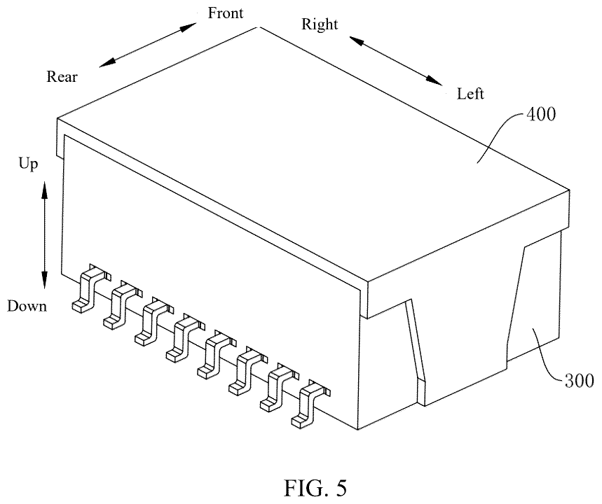

As shown in FIGS. 3-5, reference numeral 300 is a glue frame, reference numeral 310 is an external concave part, and reference numeral 400 is a cover.

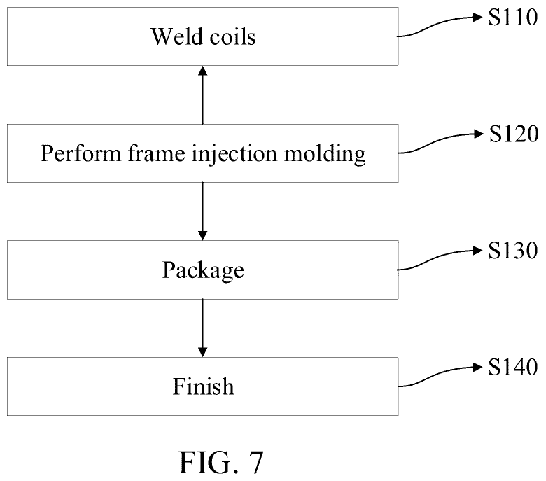

As shown in FIG. 7, S110 is welding coils, S120 is performing frame junction molding, S130 is packaging, and S140 is finishing.

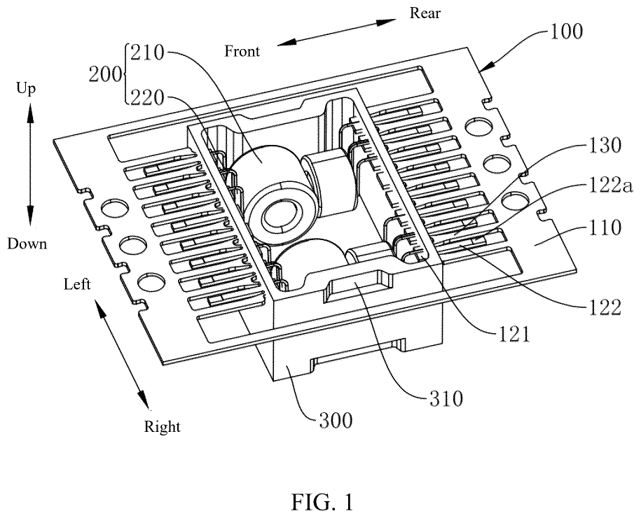

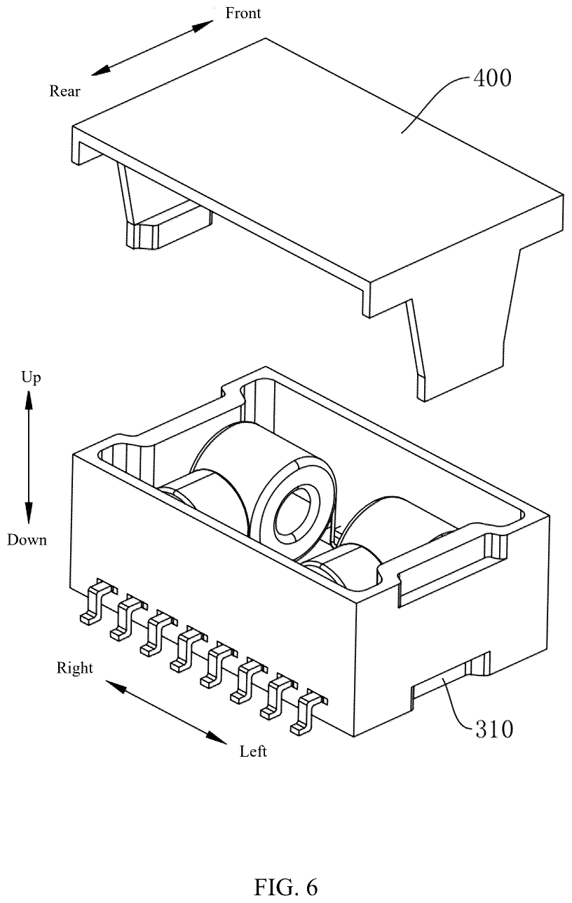

FIG. 7 is a flowchart showing a manufacturing method of an SMD network transformer. Referring to FIG. 1 to FIG. 7, a manufacturing method of a Surface Mounted Device (SMD) network transformer are illustrated below. The method includes the following steps of: S110, welding coils: taking a metal material sheet 100 and a plurality of coils 200, the metal material sheet 100 including a substrate 110, metal PINs 120 and an auxiliary sheet 130, a left side end and/or a right side end of the metal PINs 120 being connected with the auxiliary sheet 130, a cross section of the metal PINs 120 being exposed, the coils 200 including a magnetic ring 210 and a copper wire 220, tapping the copper wire 220 on the coils 200, and welding a wire end 221 of the copper wire 220 on the metal PINs 120 at a corresponding position to form welding positions 140; S120, performing frame injection molding: packaging the welding positions 140 through a glue material in an injection molding mode, the glue material forming a glue frame 300 after the injection molding, and the glue frame 300 wrapping the welding positions 140; S130, packaging: packaging the coils 200 in the glue frame 300 by using the glue material again; and S140, finishing: cutting the auxiliary sheet 130, taking down the substrate 110 and the auxiliary sheet 130 together, and bending and shaping the metal PINS 120 to form a product.

The metal material sheet 100 is provided so that all surfaces of the metal PINs 120 can be electroplated during electroplating, and the metal material sheet 100 and the metal PINs 120 are in an integral structure, which is more convenient for welding operation and injection molding and packaging the welding position 140. In addition, the injection molded glue frame 300 as an intermediate piece can provide a product base for subsequent production of network transformers in different forms, save a cost of adopting two production lines, achieve overall planning of production processes, save costs, and improve production efficiency. The coil 200 can be fixed and packaged by dispensing on a glue injection body of the glue frame 300 and the metal material sheet 100 as a whole, or the coil 200 can be completely packaged by pouring glue.

It should be noted that in the past, when manufacturing these two types of network transformers, they were packaged by mold opening and injection molding separately, and there was no case of using the glue frame 300 as the intermediate piece. In this solution, the glue frame 300 was injected as the intermediate piece to package the welding position 140, and then the coil 200 in the glue frame 300 was packaged as needed to form two products with different packaging specifications.

In some embodiments, in the packaging step, a cover 400 is further introduced. The cover 400 is mounted on a side of the glue frame 300, and the coils 200 are stuck to the glue frame 300 by dispensing at an open side of the glue frame 300. After injection molding, the glue frame 300 is fitted with the cover 400, and after the cover 400 is fitted, one side of the glue frame 300 is open, and then the coils 200 can be fixed by dispensing, so that a problem that the coils 200 are wrapped by the glue does not exist, and the magnetic ring 210 in the coil 200 is not stressed by the encapsulated glue, thus solving a problem of inductance value attenuation of the coil 200. It can be understood that the coils 200 are fixed by dispensing, and a relatively thin layer of soft glue is formed on a surface of the coil 200, and the coil 200 can be seen from the open side of the glue frame 300. The so-called relatively thin means that a thickness of the soft glue ranges from 0 mm to 1 mm.

In some embodiments, in the packaging step, the coils 200 are stuck in the glue frame 300 with the glue material first, and then an interior of the glue frame 300 is filled by a secondary injection molding mode, so that the coils 200 are packaged. In the manufacturing process, the flowing glue is completely blocked and controlled in a designated area, which makes the production convenient and easy to operate. Meanwhile, the coils 200 and the welding positions 140 in the glue frame 300 are packaged in the glue frame 300, so that the coils 200 are not loosened, the copper wires 220 are not scratched and the welding positions 140 of the copper wires 220 are not oxidized, so that the product quality is improved. It can be understood that the coils 200 are bonded with soft glue and packaged with phenolic molding powder, and the coils 200 cannot be seen after packaging.

In some embodiments, the glue frame 300 is provided with an external concave part 310. It can be understood that the external concave part 310 is configured to cooperated with a buckle on the cover 400 to fasten the cover.

In some embodiments, the metal PIN 120 is provided with a welding auxiliary groove 123, and in the step of welding the coils, the wire end 221 is bent and accommodated in the auxiliary welding groove 123 after being drawn out and then is welded. The welding auxiliary groove 123 provided is convenient for limiting the wire end 221 at an initial stage of welding, and is convenient for subsequent welding.

In some embodiments, two groups of metal PINs 120 are provided, the two groups of metal PINs 120 are oppositely arranged in a front-back direction, and an installation space is reserved between the two groups of metal PINs 120, and one group of metal PINs 120 includes a plurality of metal PINs 120 arranged in a left-right direction.

In some embodiments, the metal PIN 120 includes a packaging part 121 and a contacting part 122, the welding auxiliary groove 123 is arranged on the packaging part 121, and the wire end 221 is connected to the welding auxiliary groove 123 on the corresponding packaging part 121.

In some embodiments, the packaging part 121 and the contacting part 122 are integrally formed, and a width of the packaging part 121 is greater than a width of the contacting part 122, so that the packaging part 121 can be better packaged, and a strength of the packaged metal PIN 120 is improved; in addition, a stress at the joint of the packaging part 121 and the contacting part 122 can be improved, and the contacting part 122 can be bent conveniently in a later stage.

In some embodiments, a fillet structure is arranged at a joint of the packaging part 121 and the contacting part 122.

In some embodiments, the contacting part 122 is provided with a bending step 122a, and the bending step 122a is configured to bend the contacting part 122.

The embodiments of the present disclosure are described in detail with reference to the drawings above, but the present disclosure is not limited to the above embodiments, and various changes may also be made within the knowledge scope of those of ordinary skills in the art without departing from the spirit of the present disclosure.

What is claimed is:

1. A manufacturing method of a Surface Mounted Device (SMD) network transformer, comprising:
providing a metal material sheet and a plurality of coils, the metal material sheet comprising a substrate, a plurality of metal PINs and an auxiliary sheet, at least one of a left side end and a right side end of each of the plurality of metal PINs being connected with the auxiliary sheet, a cross section of each of the plurality of metal PINs being exposed, the plurality of coils each comprising a magnetic ring and a copper wire;
tapping a respective copper wire on the plurality of coils;
welding a wire end of the respective copper wire on a respective one of the plurality of metal PINs at a corresponding position to form a respective one of a plurality of welding positions;
packaging the welding positions through a glue material in an injection molding mode, the glue material forming a glue frame after the injection molding, and the glue frame wrapping the welding positions;
packaging the coils in the glue frame by using the glue material again; and
cutting the auxiliary sheet, taking down the substrate and the auxiliary sheet together, and bending and shaping the plurality of metal PINs to form a product.

2. The manufacturing method of claim 1, wherein in the packaging step, a cover is further provided, the cover being mounted on a side of the glue frame, and the coils being stuck to the glue frame by dispensing at an open side of the glue frame.

3. The manufacturing method claim 1, wherein in the packaging step, the coils are stuck in the glue frame with the glue material first, and then an interior of the glue frame is filled by a secondary injection molding mode, so that the coils are packaged.

4. The manufacturing method claim 1, wherein the glue frame is provided with an external concave part.

5. The manufacturing method of claim 1, wherein each of the plurality of metal PINs is provided with a respective one of a plurality of welding auxiliary grooves, and in the step of welding the coils, the wire end for each of the plurality of coils is bent and accommodated in a respective one of the plurality of auxiliary welding grooves after being drawn out and then is welded.

6. The manufacturing method of claim 5, wherein the plurality of metal PINs comprise a first group of metal PINs and a second group of metal PINs oppositely arranged in a front-back direction, an installation space is reserved between the first group of metal PINs and the second group of metal PINs, and both the first group of metal PINs and the second group of metal PINS comprises a plurality of metal PINs arranged in a left-right direction.

7. The manufacturing method of claim 6, wherein each of the plurality of metal PINs comprises a respective one of a plurality of packaging parts and a respective one of a plurality of contacting parts, each of the plurality of welding auxiliary grooves is defined on a respective one of the plurality of packaging parts, and the wire end for each of the plurality of coils is connected to the welding auxiliary groove on the respective one of the plurality of packaging parts.

8. The manufacturing method of claim 7, wherein the packaging part and the contacting part are integrally formed for each of the plurality of metal PINs, and a width of the packaging part is greater than a width of the contacting part.

9. The manufacturing method of claim 8, wherein a fillet structure is arranged at a joint of the packaging part and the contacting part for each of the plurality of metal PINs.

10. The manufacturing method of claim 9, wherein each of the plurality of contacting parts is provided with a respective one of a plurality of bending steps each configured to bend a respective one of the plurality of contacting parts.

11. The manufacturing method of claim 2, wherein each of the plurality of metal PINs is provided with a respective one of a plurality of welding auxiliary grooves, and in the step of welding the coils, the wire end for each of the plurality of coils is bent and accommodated in a respective one of the plurality of auxiliary welding grooves after being drawn out and then is welded.

12. The manufacturing method of claim 3, wherein each of the plurality of metal PINs is provided with a respective one of a plurality of welding auxiliary grooves, and in the step of welding the coils, the wire end for each of the plurality of coils is bent and accommodated in a respective one of the plurality of auxiliary welding grooves after being drawn out and then is welded.

13. The manufacturing method of claim 4, wherein each of the plurality of metal PINs is provided with a respective one of a plurality of welding auxiliary grooves, and in the step of welding the coils, the wire end for each of the plurality of coils is bent and accommodated in a respective one of the plurality of auxiliary welding grooves after being drawn out and then is welded.
